(19) United States
(12) Patent Application Publication
(10) Pub. No.: US 2001/0042086 A1
(43) Pub. Date: Nov. 15, 2001

(54) Print order receiving device, print receiving producing system and print order data product

(75) Inventors: Yutaka Ueda, Tokyo (JP); Hiroyuki Uemura, Tokyo (JP)

Correspondence Address: FRISHAUF, HOLTZ, GOODMAN &, LANGER & CHICK, PC, 767 THIRD AVENUE, 25TH AVE, NEW YORK, NY, 10017-2023, US

(73) Assignee: Konica Corporation, Tokyo (JP)

(21) Appl. No.: 09/767,117

(22) Filed: Jan. 22, 2001

(30) Foreign Application Priority Data
Jan. 28, 2000 (JP) 020111/2000

(51) Int. Cl. G06F 15/00; G06F 17/00; G06F 17/21; G06F 17/24

(52) U.S. Cl. 707/527

(57) ABSTRACT

In a print order receiving device comprising a display screen, an image data input section for inputting original image data of a customer, a memory, object operating means capable of processing said original image data as an original image object on said display screen for a print order, and making edition through combining plural objects including said original image, and print order information producing means for producing print order information on the basis of the result of operation of said objects, said print order information producing means produces text data having the operation information corresponding to the content of the operation for the plural objects correlated with the address at which image data of the composed original image object is present, and stores the text data in said memory.

### BACKGROUND OF THE INVENTION

This invention relates to a recording medium which is capable of being read by a computer and stores a program for editing an image object displayed on a display screen and obtaining an edited image object, and print order receiving device using such a recording medium.

Digital cameras which are capable of converting an optical image of a photographic object into digital image data and memorizing the data in a memory card or the like have been developed and already put on the market. Digital cameras are usually provided with a liquid crystal panel for image display; therefore, on the basis of memorized image data, it is possible to display a sensed image on this liquid crystal panel.

Incidentally, in contrast with a silver halide photograph etc., an image displayed on the liquid crystal panel of a digital camera is such a temporary one as to disappear by the turning-off of the power source of the digital camera, for example; therefore, there is a problem that the display by a liquid crystal panel is not suitable, in the case where the image is to be appreciated for a long time. Further, in some cases it is desirable to provide an image, which has been taken for plural persons as the photographic object by a digital camera, to each of them after the shot; however, there is a problem that, although it is possible to copy the image data themselves, a person who has no image display means can not appreciate this image, if a memory medium or the like in which the copied image data are memorized is provided to him as it is.

For this purpose, it is possible that image data memorized in the memory medium are read by a personal computer or the like and the image is displayed on a display, or the image is printed through a printer connected to the personal computer. However, because peripheral apparatus such as a personal computer and a printer are generally high-priced, it can not be said that all persons who are willing to appreciate an image sensed by a digital camera can use a personal computer etc. Accordingly, it has been needed a system for making it possible to appreciate an image sensed by a digital camera in a simpler way.

For the above-mentioned problems, for example, it has been considered a service such that an image is printed on the basis of image data obtained through the sensing by a digital camera. This service is such one that if a customer brings a recording medium in which image data are memorized to a laboratory or the like, the laboratory outputs prints from such image data, and provides the prints in exchange for the specified charge to the customer. It is not necessary for a customer who utilizes such a service to own any particular apparatus for printing an image, and he can obtain prints simply in just the same way as silver halide photography etc.

However, in the case where an image is formed on the basis of image data sensed by a digital camera, in order to obtain an image quality of the same level as a silver halide photograph, a simple apparatus such as a versatile printer capable of being connected to a personal computer is not suitable, and an image forming apparatus having a higher accuracy is required. Because such an image forming apparatus is comparatively high-priced at present point of time, the possibility for it to be introduced at once over a wide field is low. Accordingly, it is considered that, until such apparatus are introduced over a wide field, a service for printing an image of a digital camera has a form such that information including image data and an order content is received from a customer through a print order receiving device having a memory device at each of a plurality of agency shops for example, then this information is transmitted to an image forming apparatus installed in a specified place to print desired images, and after that, through the agency shop which has received the order, the printed images are provided to the customer.

Now, for example, in the case where a customer requests the printing of a composite image such as a post card or a calendar, it is a problem for him in what kind of a mode to make the print order. That is, there is no problem if the customer makes the composition of the image beforehand using a personal computer etc.; however, not all customers are in an environment always capable of composing an image, but it is expected that, in most cases, image composition is carried out at the time of print order. However, it takes a considerable long time for a customer to explain the content of the image composition in detail to the agency shop, and as the result of that, such an image composition as to satisfy the customer can not always be obtained.

On the other hand, it can be thought of that a customer himself carries out image composition using a personal computer etc. installed in the agency shop, but it is considered that in almost all cases it is impossible for a customer who is not inexperienced in the operation to carry out the desired image composition using an image processing software for versatile use and a personal computer.

### SUMMARY OF THE INVENTION

On the other hand, it can be considered to arrange a dedicate terminal in every shop, but there is a possibility to produce a big problem in the order reception if image processing takes too long a time. Further, there is some need of apprehension for the possibility to erase an image of a customer (an original image) through an error during the processing of the image in the shop or for the possibility to destroy the image to the extent not to be recovered. Further, it is necessary to process the image after editing quickly in an image forming apparatus, and it becomes a big problem in what form to prepare the order information including image data for that purpose. It is necessary to actualize all of the following, to state it concretely, making possible quick editing and ordering at a storefront, making high the speed of the processing in an image forming apparatus, and further, making it possible to print an edited image desired by a customer reliably.

Therefore, in view of the above-mentioned points of problem in the conventional technology, it is an object of this invention to make it possible even for a person who is not inexperienced in the operation to carry out image composition easily as well as to obtain a print image quickly and reliably as described above.

The above-mentioned object can be accomplished by any one of the following structures.

A print order receiving device comprising a display screen, image data input section for inputting original image data of a customer, a memory, object operating means capable of processing said original image data as an original image object on said display screen for a print order, and making an edition through combining plural objects including said original image object, and print order information producing means for producing print order information on the basis of the result of operation of said objects, wherein said print order information producing means produces text data having the operation information corresponding to the content of operation for the plural objects correlated with the address at which image data of the composed original image object is present, and stores the text data in said memory.

A print receiving producing system comprising a print order receiving device, an image forming apparatus for producing prints, and data transfer means for transmitting print order information from said print order receiving device to said image forming apparatus, wherein said print order receiving device comprises a display screen, image data input section for inputting original image data of a customer, a memory, object operating means capable of processing said original image data as an original image object on said display screen for a print order, and editing an image through combining plural objects including said original image object, and print order information producing means for producing print order information on the basis of the result of operation of said objects, said print order information producing means produces text data having the operation information corresponding to the content of operation for the plural objects correlated with the address at which image data of the composed original image object is present, and stores the text data in said memory, and said image forming apparatus, when receiving print order information, reproduces an image corresponding to the result of operation of the print order receiving device on the basis of the original image, in accordance with said text data in said print order information, and practices print production.

A print order data product capable of being read by a computer comprising a folder having an ID for specifying a print order of a customer, original image data in the order of the customer stored in said folder, and edition data which are stored in said folder and indicate the content of composition for plural objects including said original image object corresponding to said original image data, wherein said edition data is text data, and is a text file in which first text data corresponding to the address of the original image data, and second text data indicating the operation for the composition with said plural objects are stored as they are coupled.

Further, the above-mentioned object can be accomplished by any one of the following desirable structures.

A recording medium of the first one of this invention which stores a program and is capable of being read by a computer is a recording medium capable of being read by a computer storing a program for producing a composite object to be obtained by combining plural objects on a display screen,

wherein, when the editing operation of objects displayed on the display screen is carried out on the basis of object data, the rotation, movement, enlargement, or reduction of the object is prohibited, depending on the kinds of the object in process of edition.

A recording medium of the second one of this invention which stores a program and is capable of being read by a computer is a recording medium capable of being read by a computer storing a program for editing an image object displayed on a display screen, wherein there are provided

a first icon for selecting a mode in which a frame is displayed on said display screen, an image object is displayed in said frame, and said frame and the image object displayed in said frame can be edited integrally, and

a second icon for selecting a mode in which said frame is displayed fixedly and only the object displayed in said frame can be edited, and

the selection of mode by said first icon and the selection of mode by said second icon are alternative.

A recording medium of the third one of this invention which stores a program and is capable of being read by a computer is a recording medium capable of being read by a computer storing a program for obtaining an edited image object by editing an original image object displayed on a display screen,

wherein it is automatically produced and stored text data having the information on the condition of said editing coupled with the address, at which image data of the original image object having been used for obtaining an edited image object is present.

A recording medium of the fourth one of this invention which stores a program and is capable of being read by a computer is a recording medium capable of being read by a computer storing a program for obtaining an edited image object by editing an original image object displayed on a display screen,

wherein it is automatically produced and stored text data having the data for producing prints coupled with the address, at which image data of the original image object having been used for obtaining an edited image object is present.

A print order receiving device of the fifth one of this invention is a print order receiving device which produces print order information by producing a composite object obtained by combining plural objects on a display screen,

wherein when the editing operation of objects displayed on the display screen is carried out on the basis of object data, the rotation, movement, enlargement, or reduction of the object is prohibited, depending on the kinds of the object in process of edition.

A print order receiving device of the sixth one of this invention is a print order receiving device which produces print production information by editing image objects displayed on a display screen,

wherein a first icon for selecting a mode in which a frame is displayed on said display screen, an image object is displayed in said frame, and said frame and the image object displayed in said frame can be edited integrally, and

a second icon for selecting a mode in which said frame is displayed fixedly and only the object displayed in said frame can be edited are provided, and

the selection of mode by said first icon and the selection of mode by said second icon are alternative.

A print order receiving device of the seventh one of this invention is a print order receiving device which produces print order information by editing an original image object displayed on a display screen and producing an edited image object,

wherein it is automatically produced and stored text data having the information on the condition of said editing coupled with the address, at which image data of the original image object having been used for obtaining edited image object is present.

An print order receiving device of the eighth one of this invention is a print order receiving device which produces print order information by editing an original image object displayed on a display screen and producing an edited image object,

wherein it is automatically produced and stored text data having the data for producing prints coupled with the address, at which image data of the original image object having been used for obtaining edited image object is present.

According to a recording medium of the first one of this invention which stores a program and is capable of being read by a computer, in a recording medium capable of being read by a computer storing a program for producing a composite object to be obtained by combining plural objects on a display screen, when the editing operation of objects displayed on the display screen is carried out on the basis of object data, the rotation, movement, enlargement, or reduction of the object is restricted or prohibited, depending on the kinds of the object in process of edition; therefore, the image editor can carry out the editing operation without making any judgment for himself about whether the object to edit is capable of rotation, movement, enlargement, or reduction. Owing to this, in addition to it that edition can be carried out quickly, it is possible to suppress an error occurring at the time of producing a print for the edited object, for example. It is assumed herein that an object means an image to become the object of edition.

Further, an icon for rotating, moving, enlarging, or reducing the aforesaid displayed object on a display screen is displayed on the aforesaid display screen, and if the rotation, movement, enlargement, or reduction is prohibited through making ineffective the operation by the aforesaid icon, the image editor can carry out the editing operation for the object of edition without making for himself any judgment about whether the object is capable of rotation, movement, enlargement, or reduction through operating said icon; therefore, editing can be more quickly carried out. In addition, an icon means a character or a figure displayed on a display screen, but it is not limited to this.

Further, if the rotation, movement, enlargement, or reduction of an object is prohibited by not displaying on the aforesaid display screen the icon for rotating, moving, enlarging, or reducing the aforesaid displayed object on a display screen, the image editor can carry out the editing operation for the object of edition without making for himself any judgment about whether the object is capable of rotation, movement, enlargement, or reduction through operating said icon; therefore, editing can be more quickly carried out.

Further, if the rotation of an object by the aforesaid icon is prohibited in the case where the kind of the object in process of editing is a character based on the character information, an error, for example, such that a printed character is reversed top down can be prevented. In the above, a character based on the character information means, for example, such one as a character inputted by a code, and does not include an image of a character read by an image sensor.

Further, it is desirable that the data of the aforesaid composite object obtained by composition is used for print production.

According to a recording medium of the second one of this invention which stores a program and is capable of being read by a computer, in a recording medium capable of being read by a computer storing a program for editing an image object displayed on a display screen, there are provided a first icon for selecting a mode in which a frame is displayed on said display screen, an image object is displayed in said frame, and said frame and the image object displayed in said frame can be edited integrally, and a second icon for selecting a mode in which said frame is displayed fixedly and only the object displayed in said frame can be edited, and the selection of a mode by said first icon and the selection of a mode by said second icon are alternative; therefore, for example, if the inside of the frame as the first icon is designated by a click or the like, only the image object can be moved, and on the other hand, if the outside as the second icon of the frame is designated by a click or the like, the image object and the frame can be integrally moved; owing to this, the efficiency of editing operation can be improved.

Here, a frame includes not only a rectangle, but also a circle, an ellipsoid, a polygon, and other shapes.

Further, it is desirable that the aforesaid edition includes at least any one of rotation, enlargement, reduction, and movement.

According to a recording medium of the third one of this invention which stores a program and is capable of being read by a computer, in a recording medium capable of being read by a computer storing a program for obtaining an edited image object through editing an original image object displayed on a display screen, it is automatically produced and stored text data which having the information on the condition of said editing coupled with the address, at which image data of the original image object having been used for obtaining edited image object is present; therefore, text data as backup data is memorized even though the image editor is not conscious of it particularly; owing to this, in such a case as he has failed in edition, he can read out the original image data on the basis of the memorized address, and can do the composition over again quickly from the image data and the memorized information on the condition of edition; that is convenient. Further, because it is text data not image data corresponding to the composed image, that is backed up, a small memory capacity is enough to it, and even in the case where a large amount of such data is to be automatically stored, a large memory capacity is not required.

Further, if a path to the storing area for storing the aforesaid text data is automatically generated, and said text data is stored in the area, even though an image editor does not designate the storing area, said text data is stored; therefore, the editing operation is made efficient.

Further, it is desirable that the aforesaid information on the condition of edition includes at least any one of the information concerning the color conversion for an original image object, the information concerning the rotation for an original image object, the information concerning the deformation for an original image object, and the information concerning the size change for an original image object.

Further, it is desirable that the aforesaid text data is made such one as to be used in print production.

According to a recording medium of the fourth one of this invention which stores a program and is capable of being read by a computer, in a recording medium capable of being read by a computer storing a program for obtaining an edited image object by editing an original image object displayed on a display screen,

wherein it is automatically produced and stored text data having the data for producing prints coupled with the address, at which image data of the original image object having been used for obtaining edited image object is present; therefore, in such a case as an image editor has failed in print production, he can read out the original image data on the basis of the memorized address, and can do the print production over again quickly from the image data and the memorized information for producing prints; that is convenient. Further, because it is text data not image data corresponding to the composed image, that is backed up, a small memory capacity is enough to it, and even in the case where a large amount of such data is automatically stored, a large memory capacity is not required.

Further, it is desirable that the aforesaid data for print production includes at least any one of the information on who has made the aforesaid edition, the information on when the aforesaid edition was made, and the information on a service of print production.

Further, if the image data of the thumbnail image of the aforesaid original image object is stored as coupled with the aforesaid text data, an image editor can easily recognize a necessary image by looking at the thumbnail images displayed on a display screen; that is convenient.

Further, if the image data of the thumbnail image of the aforesaid edited image object is stored as coupled with the aforesaid text data, an image editor can easily recognize a necessary image by looking at the thumbnail images displayed on a display screen; that is convenient.

According to a print order receiving device of the fifth one of this invention, in a print order receiving device which produces print order information by producing a composite object obtained by combining plural objects on a display screen, when the editing operation of objects displayed on the display screen is carried out on the basis of object data, the rotation, movement, enlargement, or reduction of the object is prohibited, depending on the kinds of the object in process of edition; therefore, the image editor can carry out the editing operation without making any judgment for himself about whether the object of edition is capable of rotation, movement, enlargement, or reduction. Owing to this, in addition to it that edition can be carried out quickly, it is possible to suppress an error etc. occurring at the time of producing a print for the edited object, for example.

Further, an icon for rotating, moving, enlarging, or reducing the aforesaid displayed object on a display screen is displayed on the aforesaid display screen, and if the rotation, movement, enlargement, or reduction is prohibited through making ineffective the operation by said icon, an image editor can carry out the editing operation for the object of edition without making for himself any judgment about whether the object is capable of rotation, movement, enlargement, or reduction through operating said icon; therefore, editing can be more quickly carried out.

Further, if the rotation, movement, enlargement, or reduction of an object is prohibited by not displaying on the aforesaid display screen the icon for rotating, moving, enlarging, or reducing the aforesaid displayed object on a display screen, an image editor can carry out the editing operation for the object to edit without making for himself any judgment about whether the object is capable of rotation, movement, enlargement, or reduction through operating said icon; therefore, editing can be more quickly carried out.

Further, if the rotation of an object by the aforesaid icon is prohibited in the case where the kind of the object in process of editing is a character based on the character information, an error, for example, such that a printed character is reversed top down can be prevented.

Further, it is desirable that the data of the aforesaid composite object obtained by composition can be used for print production.

According to a print order receiving device of the sixth one of this invention, in a print order receiving device which produces print production (or order) information by editing image objects displayed on a display screen, there are provided a first icon for selecting a mode in which a frame is displayed on said display screen, an image object is displayed in said frame, and said frame and the image object displayed in said frame can be edited integrally, and a second icon for selecting a mode in which said frame is displayed fixedly and only the object displayed in said frame can be edited, and the selection of a mode by said first icon and the selection of a mode by said second icon are alternative; therefore, for example, if the inside of the frame as the first icon is designated by a click or the like, only the image object can be moved, and on the other hand, if the outside of the frame as the second icon is designated by a click or the like, the image object and the frame can be integrally moved; owing to this, the efficiency of editing operation can be improved.

Here, a frame includes not only a rectangle, but also a circle, an ellipsoid, a polygon, and other shapes.

Further, it is desirable that the aforesaid edition includes at least any one of rotation, enlargement, reduction, and movement.

According to a print order receiving device of the seventh one of this invention, in a print order receiving device which produces print order information by producing an edited image object through editing an original image object displayed on a display screen, it is automatically produced and stored text data having the information on the condition of said editing coupled with the address, at which image data of the original image object having been used for obtaining edited image object is present; therefore, text data as backup data is memorized even though an image editor is not conscious of it particularly; owing to this, in such a case as he has failed in edition, he can read out the original image data on the basis of the memorized address, and can do the composition over again quickly from the image data and the memorized information on the condition of edition; that is convenient. Further, because it is text data not image data corresponding to the composed image, that is backed up, a small memory capacity is enough to it, and even in the case where a large amount of such data is to be automatically stored, a large memory capacity is not required.

Further, if a path to the storing area for storing the aforesaid text data is automatically generated, and said text data is stored in the area, even if an image editor does not designate the storing area, said text data is stored; therefore, the editing operation is made efficient.

Further, it is desirable that the aforesaid information on the condition of edition includes at least any one of the information concerning the color conversion for an original image object, the information concerning the rotation for an original image object, the information concerning the deformation for an original image object, and the information concerning the size change for an original image object.

Further, it is desirable that the aforesaid text data is made such one as to be used in print production.

According to a print order receiving device of the eighth one of this invention, in a print order receiving device which produces print order information by producing an edited image object through editing an original image object displayed on a display screen, it is automatically produced and stored text data having the data for print production coupled with the address, at which image data of the original image object having been used for obtaining edited image object is present; therefore, in such a case as an image editor has failed in print production, he can read out the original image data on the basis of the memorized address, and can do the print production over again quickly from the image data and the memorized information for print production; that is convenient. Further, because it is text data not image data corresponding to the composed image, that is backed up, a small memory capacity is enough to it, and even in the case where a large amount of such data is to be automatically stored, a large memory capacity is not required.

Further, it is desirable that the aforesaid data for print production includes at least any one of the information on who has made the aforesaid edition, the information on when the aforesaid edition was made, and the information on a service of print production.

Further, if the image data of the thumbnail image of the aforesaid original image object is stored as coupled with the aforesaid text data, an image editor can easily recognize a necessary image by looking at the thumbnail images displayed on a display screen; that is convenient.

Further, if the image data of the thumbnail image of the aforesaid edited image object is stored as coupled with the aforesaid text data, an image editor can easily recognize a necessary image by looking at the thumbnail images displayed on a display screen; that is convenient.

### BRIEF DESCRIPTION OF THE DRAWINGS

FIG. 1 is the top view of a print order receiving device according to the first embodiment of this invention;

FIG. 2 is a drawing for explaining the operation of a print order receiving device according to this embodiment;

FIG. 3 is a perspective view of a print producing apparatus (image forming apparatus) according to this embodiment;

FIG. 4 is a block diagram showing the structure of a print producing apparatus;

FIG. 5 is an example of the display form of the liquid crystal screen 11;

FIG. 6 is an example of the display form of the liquid crystal screen 11;

FIG. 7 is a drawing showing an example of a display mode at the time of image edition of the liquid crystal screen 11 as a display screen;

FIG. 8 is a drawing showing another example of a display mode of the liquid crystal screen 11;

FIG. 9(a), FIG. 9(b), FIG. 9(b-1), and FIG. 9(b-2) are drawings showing the structure of the backup files of a print order built up in an internal memory of the CPU 16;

FIG. 10(a) is a drawing showing a form of an order ID;

FIG. 10(b) is a drawing showing a form of a production control ID;

FIG. 11 is a conceptual drawing showing the relation between shops;

FIG. 12 is a flow chart showing the flow of an order;

FIG. 13 is a flow chart showing the generation of a print order; and

FIG. 14 is a flow chart showing the flow of production.

### DETAILED DESCRIPTION OF THE PREFERRED EMBODIMENT

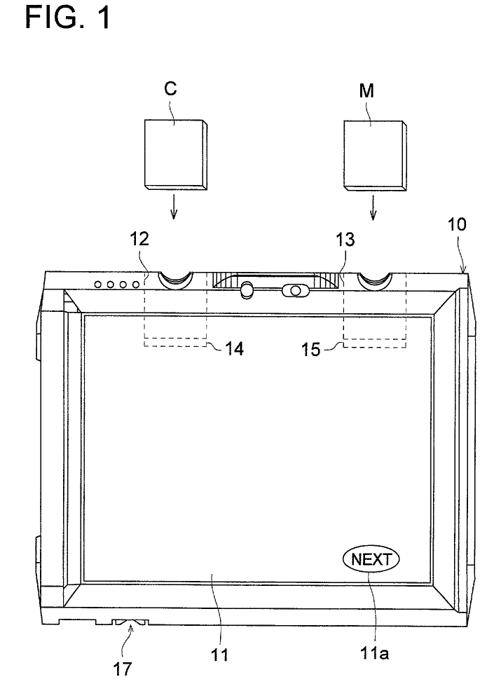

In the following, this invention will be explained by referring to the drawings. FIG. 1 is the top view of a print order receiving device according to this embodiment of the invention. In FIG. 1, the print order receiving device 10 has a shape of a rectangular plate, has the liquid crystal screen 11 of a touch-panel type provided with a display screen at the top surface, and has the power source switch 21 on the one side surface (lower side in FIG. 1). Inputting through the liquid crystal screen 11 can be done also through a mouse (not shown in the drawing) for driving a pointer displayed on the screen. Further, the print order receiving device 10 has two openings 12 and 13 in the opposite side surface (upper side in FIG. 1) formed. In the openings 12 and 13, the data reading device 14 and the reading/writing device 15 are mounted respectively.

The opening 12 is capable of receiving the removable medium C, for example a PC card, in which image data corresponding to an image sensed by a digital camera is memorized, and the opening 13 is capable of receiving the removable medium M, for example a PC card, as a memory means or a memory medium. It is desirable that the removable medium M has a larger memory capacity than the removable medium C in the state that there are no data memorized in both of them, that is, in the vacant state. Further, for the removable media C and M, not only a PC card shown here or an IC card, but also various memory media such as a photo-magnetic disk, a DVD-RAM, and a CD-R can be utilized.

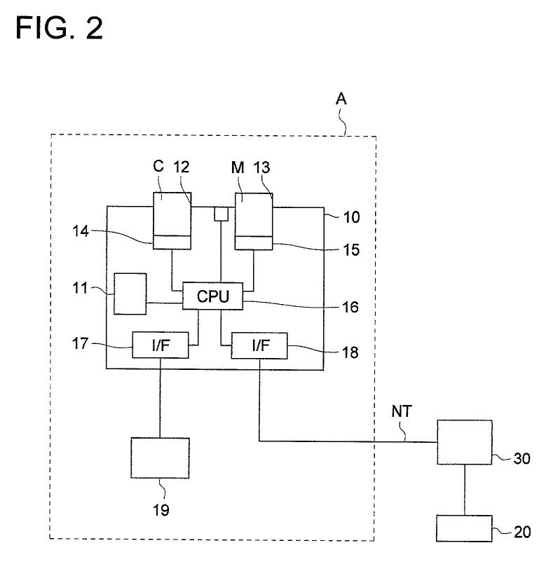

FIG. 2 is a drawing for explaining the operation of the print order receiving device 10 according to this embodiment. In FIG. 2, the print order receiving device comprises the reading device 14 which is capable of reading image data from the removable medium C inserted in the opening 12, the reading/writing device 15 which is capable of letting image data and print order information (to be described later) be memorized in the removable medium M, and a control section connected to these. The control section has the CPU 16 for executing a program, which can be memorized in a flash memory (not shown in the drawing). Further, in the control section, an SDRAM (not shown in the drawing) is included. It is possible to make the flash memory capable of being mounted to and dismounted from the CPU 16, but it is also possible to arrange it fixedly. Further, it is also possible to update the program by replace or rewrite this flash memory. The CPU 16 is capable of processing the specified information inputted from the liquid crystal screen 11 of a touch-panel type, while it is also capable of displaying a specified image on the liquid crystal screen 11 through a driver (not shown in the drawing).

The print order receiving device 10 comprises the interface 17 of a type such as RS-232C or USB (Universal Serial Bus) for the CPU 16 to transmit character data to the character printer 19.

This can be utilized in printing a slip for confirmation at the time of producing print order information by a customer.

Further, in order to transmit order information to the external image forming apparatus 20, it comprises a terminal (the interface 18) for communicating through a network of 10 BASE-T, 100 BASE-TX, or the like. Therefore, it is capable of being connected to Internet NT using a VAN-connecting device such as a dial-up router, and transmitting print order information to the server 30. In the server 30, it is possible to practice printing, through producing data for printing on the basis of the transmitted data and referring to the data for printing from by the image forming apparatus 20.

In the following, the specification of the print order receiving device 10 according to this embodiment will be explained.

CPU: VR4310 (167MHz) or VR5432 (167MHz)

Memory: SDRAM, 64 Mbyte

Flash memory, 28 Mbyte

Display: LCD, 12.1 inch TFT color LCD panel

VRAM, UMA type (using the main memory)

Resolution/Number of colors, 600×800 pixels presented in 65,536 colors (16 bits)

LED, 4 pieces of two-color (red/green) LED installed

Operation section:

touch panel, resistor film type analogue touch panel electrical resolution, 10 bits (1024×1024)

versatile switch, left-and-right Up/Down Clock: year/month/minute/second and 114 byte versatile SRAM

lithium battery and backup by super-capacitor External interface: PCMCIA, two Type II slots installed

Serial, two D-sub 9-pin connectors installed

USB, one USB connector installed

IrDA, one IrDA transmission-reception module installed

10BASE-T, one 10BASE-T connector installed

Power source: power supply, DC 19V supplied from AC adapter power consumption under 40 W

Outer dimension: 252 mm×316.7 mm×30 mm

Weight: 1600 g (AC adapter not included)

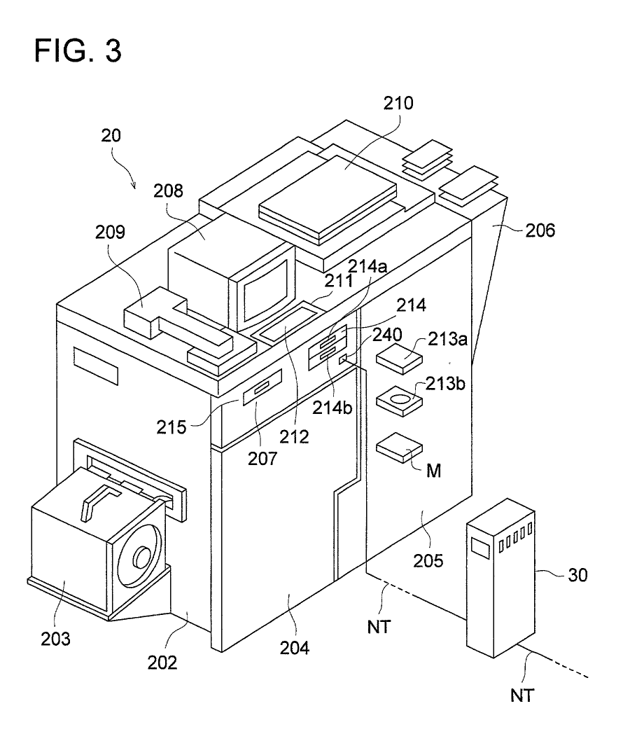

FIG. 3 is a perspective view of a print producing apparatus (image forming apparatus) according to this embodiment. In this drawing, for the print producing apparatus 20 as an example of an image forming apparatus to be installed in a laboratory etc., such one as to produce prints by applying an exposure and development to a photosensitive material is shown as an example, but it is not limited to this, and any one that can produce prints on the basis of image information is appropriate; for example, a print producing apparatus of an ink jet type, or of an electro-photographic type may also be suitable, but in particular, in this invention, a type using a photosensitive material is desirable.

The print producing apparatus 20 of this embodiment is provided with the magazine loading portion 203 on the left side of the mainframe 202. Inside the mainframe 202, there are provided the exposure processing section 204 which makes exposure for a photosensitive material as a memory medium, and the print producing section 205 for producing prints, and the produced prints are ejected onto the tray 206 provided on the right side of the mainframe 202. Further, inside the mainframe 202, the control section 207 is provided at a position above the exposure processing section 204.

Further, on the top surface of the mainframe 202, the CRT 208 is arranged. This CRT 208 makes up the display means for displaying the image based on the image information to produce a print on the screen. In the left side space of the CRT 208, the film scanner section 209, which is the image reading section to read a transmitting original, is arranged, and in the right side area of the CRT 208, the reflecting original input device 210 is arranged.

For an original to be read by the film scanner section 209 or the reflecting original inputting device 210, a photographic photosensitive material can be cited, and for this photographic photosensitive material, a color negative film, a color reversal film, a black and white negative film, a black and white reversal film, etc. can be cited; data of an image which has been taken by an analogue camera is memorized. By converting the image into digital information by a film scanner in the film scanner section 209, image data can be obtained. Further, in the case where the photographic photosensitive material is a color photographic paper, image data can be obtained by a flat bed scanner in the reflecting original inputting device 210.

Further, at the position of the control section 207 in the mainframe 202, the image transfer section 214 is provided. In the image transfer section 214, in addition to the above-mentioned removable medium M (PC card), the IC card 213a, the floppy disk 213b, etc., in which image data is memorized, can be inserted, and image data etc. of the inserted memory medium are to be read out.

In the front side area of the CRT 208, there is arranged the operation section 211, in which the information inputting means 212 is provided; the information inputting means 212 is made up of a touch panel, for example.

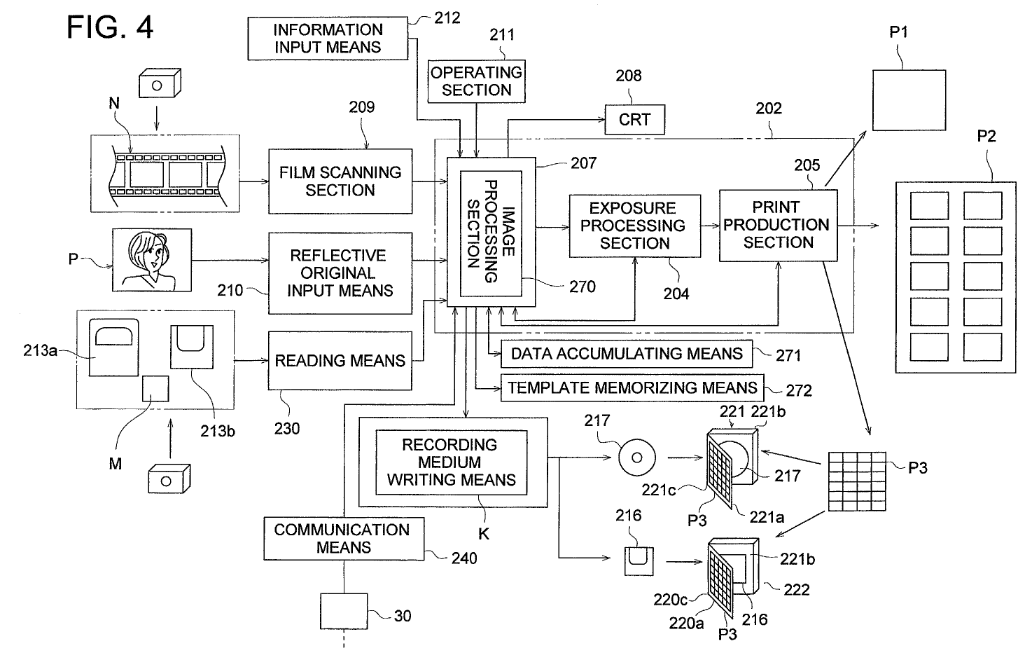

Further, in the mainframe 202, there is provided the memory medium writing section 215, in which it is provided the writing means K (FIG. 4) for writing image data in the removable medium M or the like having image data into a magnetic memory medium, an optical memory medium, or the like, when a print is produced through outputting image data from the memory medium.

For the memory medium to memorize image data, to state it concretely, removable media such as a multi-media card, a memory stick, an MD, and a CD-ROM can be cited, but it is not limited to these.

Further, the operating section 211, the CRT 208, the film scanner section 209, the reflecting original inputting device 210, the image transfer section 214, and the memory medium writing section 215 are provided integrally in the mainframe 202 to make up the structure of the apparatus, but it is also appropriate to provide any one or more of them as a separate device.

FIG. 4 is a block diagram showing the structure of a print producing apparatus.

The control section 207 of the print producing apparatus 20 practices the reading of original information from the film scanner section 209 or the reflecting original inputting device 210, on the basis of the instructing information from the information inputting means 212, and obtains image information to display it on the CRT 208.

Further, the print producing apparatus 20 comprises the data accumulating means 271 and the template memorizing means 272. In the data accumulating means 271, image data having been read in from the removable medium M and the print order information corresponding to them (the information how many prints are to be produced from which frame of image, the information on print size, etc., to be describe later in detail) can be memorized and accumulated successively. From the film scanner section 209, it is inputted a frame of image from the developed negative film N, which is obtained by developing a negative film having been subjected to photographing by an analogue camera, and from the reflecting original inputting device 210, it is inputted a frame of image from the print P which has been obtained by printing a frame of image on a photographic paper sheet and develop-processing it.

In the template memorizing means 272, data of at least one template image for setting a composing area with a background image, and data concerning the number corresponding to the above are memorized beforehand. By the operation of an operator, or in accordance with the number of the template image included in the print order information, the particular template image is specified out of the plural template images memorized beforehand in the template memorizing means 272, the image data is combined with the selected template image, and a print is produced on the basis of the composed image data. This composition with a template image is carried out by the well known chromakey method.

Further, the control section 207 comprises the image processing section 270, in which image information is processed to form image information for exposure and it is sent to the exposure processing section 204. In the exposure processing section 204, exposure to an image is carried out for a photosensitive material, which is sent to the print producing section 205, in which the exposed photosensitive film is develop-processed and dried, to produce a print.

In the image transfer section 214 of this print producing apparatus 20, there are provided the reading means 230 for reading out and transferring image data etc. of the removable medium M etc., and the communication means 240 capable of communicating with the print order receiving device. The reading means 230 can read out image data memorized in the removable medium M which is inserted in the image transfer section 214, and transfer them to the control section 207 which is made up of a microcomputer. On the other hand, the communication means 240 is capable of communicating with the print order receiving device 10 through Internet or the like, and inputting image data etc.

In this print producing apparatus 20, in accordance with image data memorized in the removable medium M and the print order information which is memorized in correspondence with the image data, the usual print P1, the file print P2, and the index print P3 can be produced.

The ordinary print P1 is a sheet of print produced from data of a frame of image. In the production of this ordinary print P1, through setting a specified composing area in a background image having a specified pattern (template image) for example, and combining a frame of image with this composing area to memorize it, a print P1 of the ordinary print size decorated with a photo-frame can be produced. In this way, by memorizing a piece of image data for a sheet of the print P1, for example, a post card, a calendar, or a desired special print capable of being contained in a wallet or in a commutation-ticket holder can be produced in response to the request of a customer.

Further, the file print P2 is one produced as a large-sized file of a sheet from a plurality of frames of image. In the production of this file print P2 too, it is possible that, for example, in a background image having the specified pattern, 3 to 10 composing areas, for example, are set at different positions, to combine one frame of image for each of these 3 to 10 composing areas to memorize it. Further, in the file print P2, it is appropriate to memorize a line along which to cut off in a background image, and it is possible by this line along which to cut off to produce a desired special print capable of being easily and nicely cut off and contained in a wallet or a commutation-ticket holder. Composition of an image can be carried out by the print order receiving device 10 as will be described later.

The index print P3 is a sheet of print of a specified size produced from all frames of image on the basis of image data for the convenience of a second print order etc.

In this print producing apparatus, in order to print an image of a developed negative film or a developed reversal film, it is possible to produce prints in the same way through the control section 207, after the image of these films is scanned by the film scanner in the film scanning section 209, and is converted into digital information.

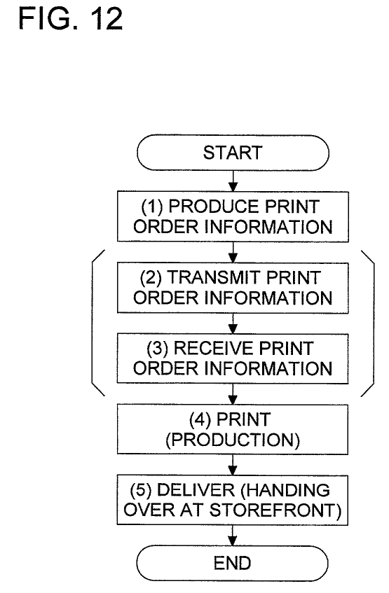

First, to explain the flow of operation simply, as shown in FIG. 12, a customer carries out preparation of print order information (FIG. 12(1)). This preparation is made by using a print order receiving device in this example of practice, but it is appropriate to prepare it by using a personal computer connected with Internet; it is not necessary to be particular about the way of preparation.

In the case where WAN such as Internet is used, the prepared print order information is transmitted (FIG. 12(2)), is received at the shop (FIG. 12(3)), and is memorized in a server. In the shop, prints are produced from the information memorized in the server (FIG. 12(4)), and are delivered to the customer (FIG. 12(5)).

In addition, in such a case that print order information is prepared at the storefront and printing is carried out on the spot, the part of the steps stated in the parenthesis in FIG. 12 is unnecessary, and reception and delivery is accomplished on the spot without transmitting information.

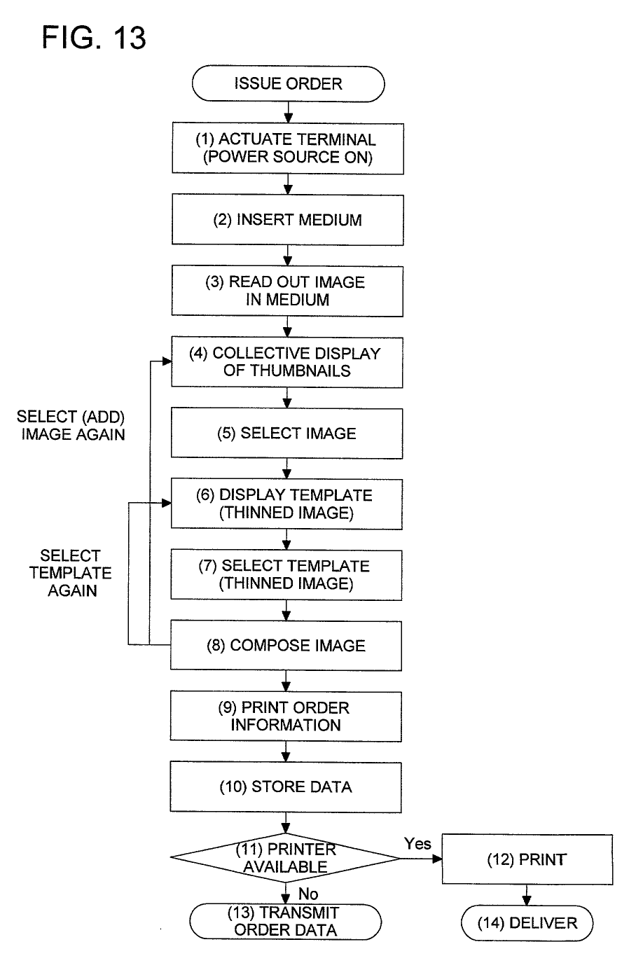

Next, the operation of a print order receiving device according to this embodiment will be explained by referring to FIG. 1 and FIG. 2. It is desirable that the print order receiving device 10 according to this embodiment is installed in a print agency shop, a convenience store, etc. (hereinafter referred to as the agency shop A) which have no image forming apparatus capable of forming an image with a high definition on the basis of image data. A customer who requests printing brings the removable medium C in which image data corresponding to an image sensed by his digital camera to the agency shop A. In addition, for the removable medium, any kind of it will do so long as it is a memory medium that is capable of memorizing image data and is portable. Further, the operation concerning print order may be done by an operator of the agency shop A, but it is assumed that the customer (referred to as the editor) carries it out on his own in this embodiment. By referring to FIG. 13, the procedure concerning print production using a print order receiving device will be explained.

In ordering prints, when a customer turns on the power switch 17 of the print order receiving device 10 (FIG. 13(1)), a program for preparing print order information is actuated, to bring the device into the state capable of operation, and the initial display is presented on the liquid crystal screen 11.

Now, when the customer inserts the removable medium C as a removable medium into the opening 12 of the print order receiving device 10 (FIG. 13(2)), a sensor (not shown in the drawing) detects that the removable medium C is fixed at the position where image data can be read, and transmits a signal indicating that reading is enabled. In response to this signal indicating that reading is enabled, the reading device 12 reads out the image data memorized in the removable medium C (FIG. 13(3)). The CPU 16 can first memorize the image data having been read out in the removable medium M, and then on the basis of the read out image data, display all the images corresponding to the image data memorized in the removable medium C as an index on one display of the liquid crystal screen 11 (FIG. 13(4)).

In the case where, with respect to one and the same image, image data of the full-sized image and the image data of the thumbnail image having a smaller data volume than the full-sized image are memorized in the removable medium C, in the above-mentioned index display, images are displayed on the basis of the thumbnail image data. Further, it is also appropriate that, in the case where image data having a small data volume is not memorized, the index display is done by generating image data having a small data volume from the read out data of the full-sized image.

The customer, looking at this index display, selects the image of which he asks for printing by pressing a portion of the liquid crystal screen 11 (FIG. 13(5)). In this case, for the image which has been pressed in the liquid crystal screen 11, by the CPU 16 changing the color of its frame for example, it can be recognized at a glance which image has been selected, which is convenient.

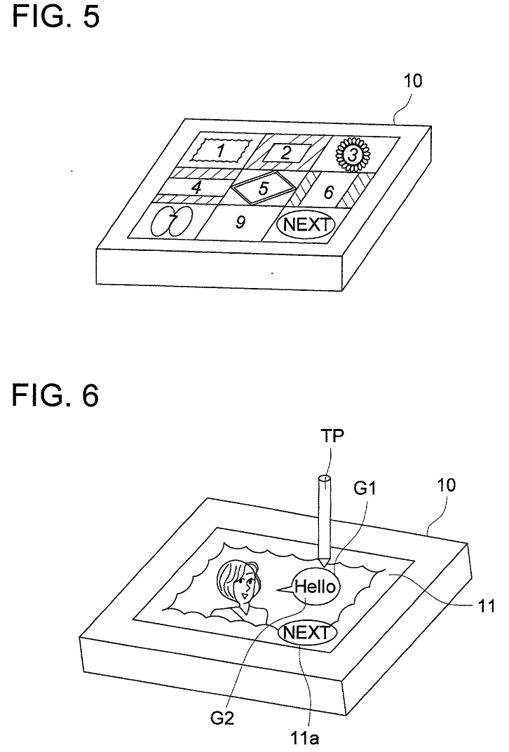

When the selection is finished, by the customer pressing the “NEXT” button 11a (refer to FIG. 5) displayed at the lower right portion on the liquid crystal screen 11, as shown in FIG. 5, the CPU 16 displays the memorized template images (images obtained by thinning out the image data of the high-definition template image, hereinafter referred to as thinned image data) and the corresponding number as an index (FIG. 13(6)). The customer, looking at this display, selects the template image with which he wishes to combine his objective image by pressing the portion of the liquid crystal screen 11 (FIG. 13(7)). In this case, with respect to the image pressed on the liquid crystal screen, by the CPU changing the color of its frame for example, it can be recognized at a glance which image has been selected, which is convenient. Further, in the case where he does not with composition, he has only to press the number 9 which indicates that the composition with the template image is not to be made.

When the selection is finished, by the customer pressing the “NEXT” button 11a displayed at the lower right portion on the liquid crystal display 11, the CPU 16 combines the thumbnail image data of the objective image with the thinned image data, and on the basis of the composite data, displays the composite image on the liquid crystal screen 11 as shown in FIG. 6.

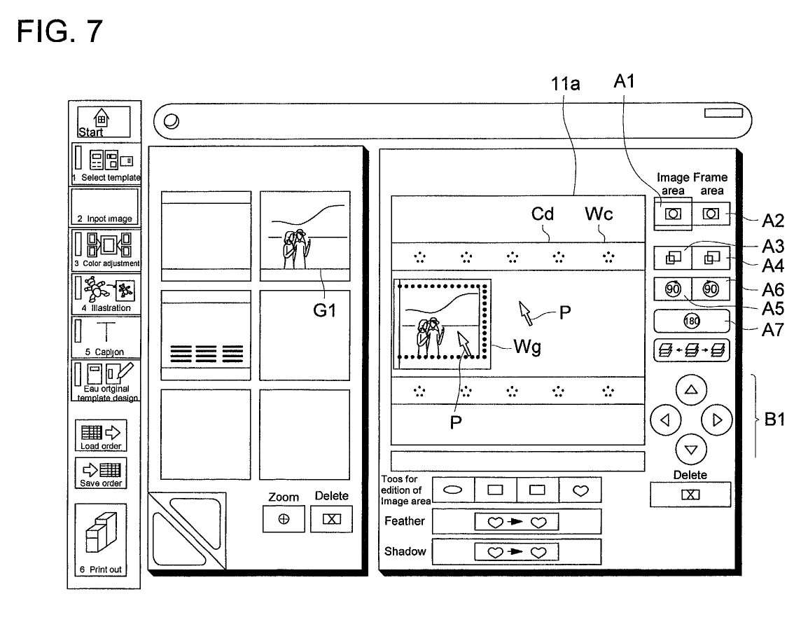

Now, the various modes of image composition such as making an image frame for a template, the layout of an image (rotation, enlargement, reduction, etc.), making a frame for characters for a template, inputting a string of characters, and the change of arrangement will be explained (FIG. 13(8)). FIG. 7 is a drawing showing an example of a display mode of the liquid crystal screen as a display screen at the time of image edition. In FIG. 7, the calling card Cd to be edited is displayed in a surrounding frame Wc in the rectangular-shaped edition area 11b. The design of this calling card Cd can be selected out of those memorized beforehand as shown in FIG. 5.

In the calling card Cd, out of the selectable images displayed in the right side, the image G1 as an image object requested to edit is selected and inserted. Around the image G1, the frame Wg like a picture frame is displayed. Moreover, as shown by the dotted line (this line is not displayed actually), the original image G1 is larger than the frame Wg, and only the portion of the image G1 gouged out by the frame Wg is to be displayed.

Now, if the image editor judges that the position of the frame Wg is suitable, but the position of the image G1 being gouged out is unsuitable, he can click the icon A1 at the upper right position in the edition area 11b (the second if icon). By doing it, the CPU 16 as a recording medium having a program stored sets a mode for editing only the image G1 displayed in the frame Wg on the basis of this program. In this mode, as the position of the frame Wg is fixed, editing such as moving the image G1 arbitrarily can be carried out, in response to the operation of the image moving button B1 by the editor or the drag by a mouse (not shown in the drawing).

On the other hand, if the editor judges that the position of the image G1 being gouged out is suitable, but the position of the frame Wg is unsuitable, he can click on the icon A2 at the upper right position in the edition area 11b. By doing it, the CPU 16 sets a mode for editing the frame Wg and the image G1 integrally on the basis of the program. In this mode, editing such as moving the image G1 and the frame Wg integrally to an arbitrary position can be carried out, in response to the operation of the image moving button B1 by the editor or the drag by a mouse (not shown in the drawing).

Moreover, the frame includes not only a rectangle, but also a circle, an ellipsoid, a polygon, or other shapes, and also includes one not displayed in the edition area 11a. Further, instead of clicking on the icon A1 or A2, it is appropriate that, by moving the pointer P to the inside of the frame Wg and clicking on it, a mode for carrying out a single-object edition for the image G1 only is set, and on the other hand, by moving the pointer P to the outside of the frame Wg and clicking on it, a mode for carrying out an integral edition for the image G1 and the frame Wg is set. Further, in the above example, movement is cited as an example of edition, but an edition such as reduction based on the icon A3, enlargement based on the icon A4, or rotation based on the icons A5 to A7 can be carried out as the occasion demands, and owing to it, efficiency of edition can be improved.

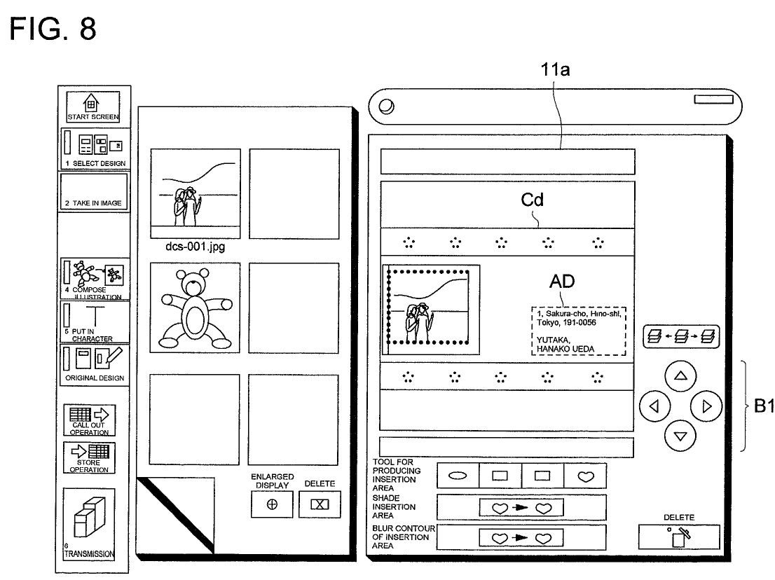

FIG. 8 is a drawing showing another display mode of the liquid crystal display 11. In FIG. 8, it is assumed that the image editor has inserted the image of his address AD at a lower right position in the calling card Cd. Here, in this embodiment, the image of the address AD as the characters formed on the basis of the character information such as character codes is incapable of rotation, enlargement, reduction, but capable of only movement.

In this case, as shown in FIG. 8, in response to the click on the image of the address AD (inside the frame surrounded by the dotted line) by the editor, the CPU 16 makes the icons A3 to A7 not displayed (FIG. 7), and by doing it, the rotation, enlargement, and reduction of the image of the address AD are prohibited, while it lets the editor recognize that he can not carry out those, which improves the efficiency of edition. In addition, the button B1 is displayed on the liquid crystal screen 11, and owing to it, the editor can understand that the image of the address AD is capable of movement to an arbitrary position.

With respect to image data for which edition such as rotation, movement, enlargement, or change is prohibited, various modes can be considered, for example, a mode in which the CPU judges it from the extension of the data (for example, text data), and a mode in which the CPU judges it from the file in which the image data designated by the image editor is memorized.

Further, instead of making the icons A3 to A7 not displayed, it is also appropriate that, although the icons are displayed as shown in FIG. 7, they are made not to react even if the image editor clicks on them, and that makes the image editor recognize that the rotation, enlargement, and reduction of the image of the address AD can not be done. Further, in such a case that the image of the address AD occupies almost the whole area of the card Cd, it is also appropriate that also the button B1 is made not displayed and the image editor is made to recognize that even the movement of the image of the address AD can not be done.

After the composite image is confirmed and image edition is finished, the print order information is settled by inputting suitably or confirming the customer information, order information, shop information, and print information, which are to be described later, at need (FIG. 13 (9)). After that, it is appropriate that the print order information is transmitted from the print order receiving device through the Internet NT to the image forming apparatus 20 (FIG. 13(13)), or it is also appropriate that, in the case where an image forming apparatus is installed in the LAN (for example, in the agency shop) to which this print order receiving device is connected (FIG. 13(11)), printing process is carried out on the spot, of course (FIG. 13(12)). In this case, it is also possible to deliver the prints to the customer immediately (FIG. 13(14)).

Of course, it is appropriate that, without transmitting through the LAN, the print order information is memorized in the removable medium M, and the removable medium M is inserted into the reading means 230 of the image forming apparatus 20, to output prints.

For the means for transmitting print order information, such one as E-mail using an smtp may be utilized, or such one as an ftp or an http may be utilized; it is unnecessary to be particular about the means. With respect to the form of the connection between the shops, it will be explained in detail in “SHOP INF”.

The storing of print order information is carried out concurrently with these operations (FIG. 13(10)).

With respect to the storage of print order information, it is appropriate to store it temporarily in the SDRAM in the CPU 16, or to store it in the removable medium C; it is unnecessary to be particular about the kinds of the medium so long as it is capable of memorizing print order information data.

Now, in the case where it is memorized in the removable medium C, when a customer makes a second order, it is possible to prepare the same order or a different order on the basis of backup information, and in particular, as will be described later, memorizing in the removable medium C is effective to an order having little difference from the former one in the customer information, shop information, etc.

Moreover, explanation is done by using the print order receiving device 10 in this example of practice; however, this is for the explanation of the function at all, and it is appropriate to use such an apparatus as is known generally as a personal computer; in such a case as this, by memorizing print order information in a hard disk connected to this personal computer, a permanent storage becomes possible.

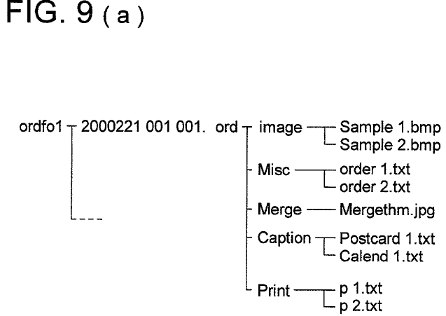

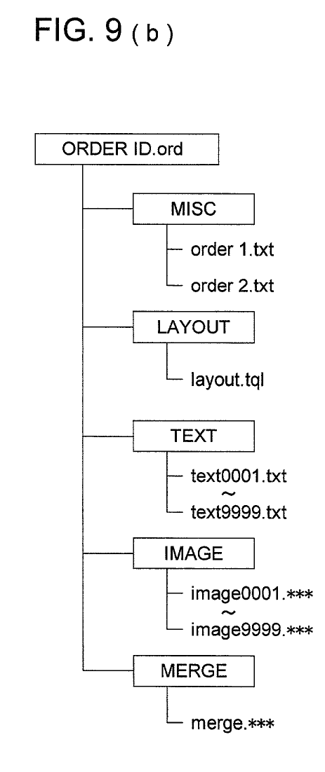

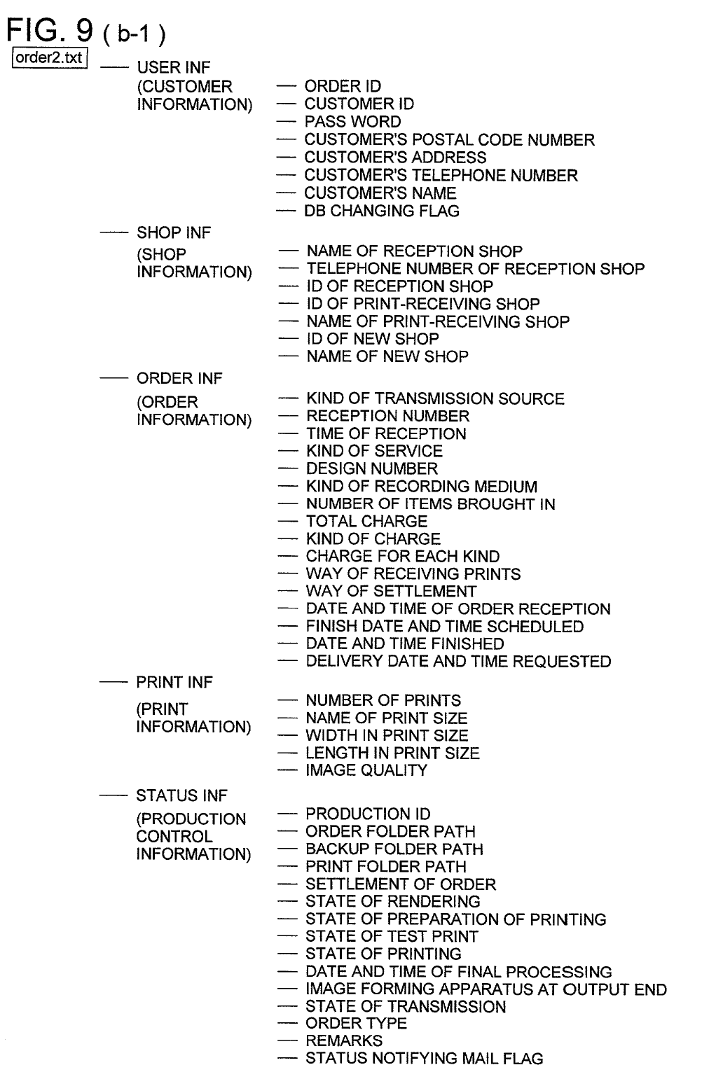

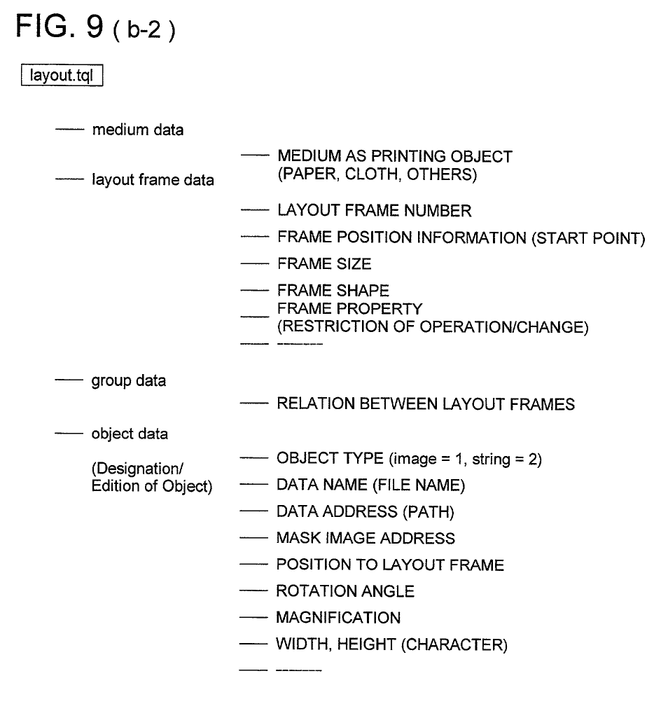

FIG. 9(a) and FIG. 9(b) are drawings showing the structures of print order information to be prepared respectively.

In FIG. (a) and FIG. 9(b), a folder including an information file necessary for printing is produced for each piece of the print order information corresponding to each order. In this example, an order ID denoting the piece of print order information corresponding to an order uniquely is defined and generated, to be used as a folder name. The identifier ord indicates that printing has not yet been finished, and if printing has been carried out by the image forming apparatus 20, it is convenient to rewrite the identifier as 001 or the like, because it makes it possible to retrieve the state of printing as real data not on the database of the system.

As shown in FIG. 9(a), in the folder 2000221001001.ord (example) showing print order information, an image folder for storing image data, a Misc. folder for storing the print condition, a Merge folder for storing thumbnail images, a Caption folder for storing character data, and a Print folder concerning the print layout information are produced. FIG. 9(b) also is a drawing showing the data structure of print order information as FIG. 9(a). In the order ID.ord denoting a folder, there are provided a Misc. folder for storing the print condition, a LAYOUT folder for storing the layout information concerning the composition and edition of an image, a TEXT folder for storing character data, an IMAGE folder for storing image data, and a MERGE folder for storing thumbnail images. Hereinafter, detailed explanation will be give on the basis of FIG. 9(b). In addition, iin FIG. 9(b), the identifier *** varies depending on the image to use and the objective image to reproduce.

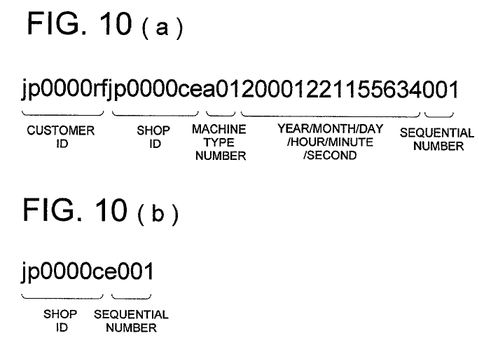

The order ID can be generated, for example, in such a form as shown in FIG. 10(a).

Here, jp0000rf indicates a customer ID, and in particular, the two figures jp in the front denotes a code for nationality, while the following 0000rf denotes the registration number. In the above, the registration number is not only composed of numerals simply but also alphabetical characters in order to increase the number of customers to represent.

Next, in the same way of thinking as the customer ID, the shop ID is connected, and for the print processing in a shop etc., a code (a machine type number) for limiting the machine type in the shop is described and connected.

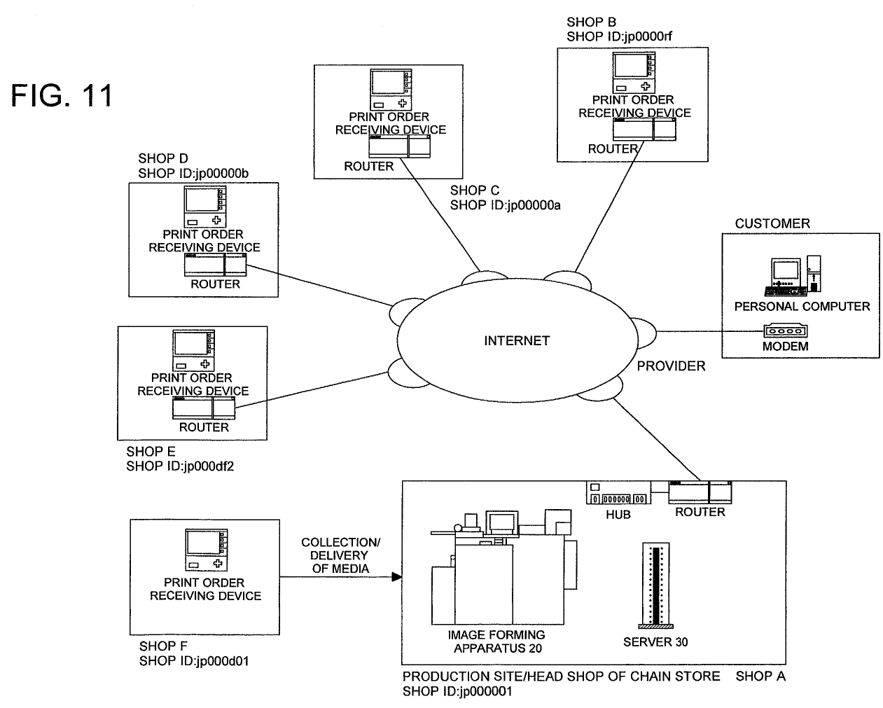

Further, the dominical year, month, day, hour, minute, and second for the time when the order is settled are connected, and a sequential three figure number is given to it in order to make it possible to identify a plurality of orders even if they are prepared at the same time. By doing this way, even if an order ID is generated at the customer side, it becomes possible to feedback the order ID to a customer earlier than the order ID is attached by the server 30 or the image forming apparatus 20. Such a form is particularly effective in the case where print order information from plural shops is accepted by a smaller number of production sites (one in the drawing) than the number of shops as shown in FIG. 11.

Moreover, with respect to the item to be connected in generating the above-mentioned ID, it is possible to select it through adoption or rejection depending on the way of practical use.

Further, it is necessary to recognize a customer by using usually the name, address, telephone number, etc. On the other hand, a customer ID is an ID for identifying a customer simply, and if the registration of customers is made for each of shop ID's, a customer ID must be unique at least to the shop ID to which it belongs. In addition, it is more desirable that a customer ID is unique to the parent shop to be described later.

However, in contrast with it that order ID's which are generated in this way are given unique numbers respectively worldwide and are suitable for the control of a database, they have multiple figures to make it difficult to transfer the number accurately sometimes. For that reason, as shown in FIG. 10(b), it is appropriate to issue it as a production control ID for temporary control, which has figures of only eleven or so including the shop ID, for convenience' sake. In addition, in this case, it is unnecessary of course to be particular about eleven figures, and it is possible to handle it in a way easy to handle. This production control ID is one put sequentially, to become saturated in some time, but it is a temporary one at all; therefore, if it is saturated, it is possible to begin with the first one (001 for example).

The structure in the “order ID” folder shown in FIG. 9(b) will be explained. To take the calling card Cd for instance in FIG. 8, the original image object used here is memorized as image00001.bmp in the “IMAGE” folder in FIG. 9(b).

Now in FIG. 9(b), it is described as image00001.***; the identifier *** is the name of image form capable of being identified in this application for example, and it is determined in Windows 95 (produced by Microsoft Corp.) as “jpg” for the jpeg form and as “bmp” for the bit map form. In the case where there are plural original image objects to be used, it is possible to cope with it by making the number larger in such a way as image00002.jpg.

With respect to the data of the name and address used in FIG. 8, the condition of edition including the font name, character size, color of character, format, direction of arrangement is memorized as a character object text0001.txt in the folder “TEXT” in FIG. 9. This is defined for each domain, and can be increased consecutively as text0002.txt.

In the “MISC” folder, the files order1.txt and order2.txt are memorized. Here, the order1.txt is described basically in a format in accordance with DPOF (Digital Print Order Format) Ver. 1.0 formulated by Canon Inc., Eastman Kodak Co., Ltd., and Matsushita Electric Industrial Co., Ltd. jointly.

In DPOF, a tag to become the object for automating printing is described, but it is not corresponding to such an edition as this invention.

On the other hand, the order2.txt is a file in which portions of the print order information effective against a problem concerning production control can be described collectively as an extended order information file (to be described later). Owing to this, it becomes possible to make print production more efficient.

Further, in the “MERGE” folder, thumbnail images are stored. The thumbnail images stored in this are not such ones that original images are simply reduced. They are composite images based on thinned images confirmed by a customer on the terminal, and it is possible to make them have a very compact data size, while they enable the confirmation of the images, which the customer have recognized at the time of ordering, simply at the time of printing as they are.

The extended order information file (order2.txt) is composed of “USER INF” denoting customer information, “SHOP INF” denoting shop information, “ORDER INF” denoting order information, “PRINT INF” denoting print information, and “STATUS INF” denoting production control information. The data structure of these is shown in FIG. 9(b-1).

“USER INF”

The “USER INF” is composed of the order ID, the customer ID, the pass word, the postal code number of the customer, the address of the customer, the telephone number of the customer, the name of the customer, and a DB change flag, and for the order ID and the customer ID, the abovementioned ones are described as they are.

The pass word is the information necessary for a customer to certify his own information through Internet or the like, and by writing with a code, it becomes possible that, even though it occurs a problem such that a text sentence leaks to others, the customer information is protected. In this case, for the merit of describing a pass word, it is possible to use it as means for certifying the transmitted print order information. (If there is an error in the description of the pass word, the order is not accepted.)

The postal code number of a customer, the address of a customer, the telephone number of a customer, and the name of a customer are those which specify the information on the customer, and are used for specifying the place for contact and the customer. Specifying a customer is important information in carrying out settlement of account etc. However, if a customer ID is described properly, this content is unnecessary, but it has such a convenience that the name of the customer can be recognized only by looking at the file, and such an advantage that the DB change flag to be described later can be utilized.

The DB change flag is utilized when it is desired to amend the information registered in the database of the customer on the basis of this print order information.

“SHOP INF”

In “SHOP INF”, the name of the reception shop, the telephone number of the reception shop, the reception shop ID, the print-receiving shop ID, the name of the print-receiving shop ID, the parent shop ID, and the name of the parent shop are described.

Now, the relation between the parent shop and the reception shop or the print-receiving shop will be explained by referring to FIG. 11. Now, to consider a photography shop X of a chain-store type, the head shop A is defined as the parent shop, and in this example of practice, it is defined as a production site equipped with an image forming apparatus.

In contrast with that, the shops B to F equipped with a print order receiving device are not required to have an image forming apparatus, and therefore, it is possible to install a print order receiving device in such a place as a drug store, or a convenience store. With respect to the reception shop, if a customer visits the shop B, for example, and carries out making a print order, the shop is defined as the reception shop. If the above-mentioned customer receives the prints finished at the shop B without changing the shops, the shop B is the print-receiving shop, but if he wishes to receive the prints at the shop C which is near to his place of employment, the shop C becomes the print-receiving shop.

Among these, the shops B to E are connected through a router to Internet, and are capable of transmitting print order information through the communication means connected with the print order receiving device, and because the shop F has no communication means, it can respond to the request of printing by collecting and delivering the media in which print order information prepared by the print order receiving device is memorized.

Further, a customer can request printing also from his home by preparing print order information using a personal computer by a program for generating print order information; however, in such a case, he may designate the parent shop as the reception shop, and if there is a shop to which he usually visits (the shop D, for example), he may designate the shop as the print-receiving shop. Further, in this case, it is possible to store the program in the disk in the personal computer, but it is also possible to execute the program for generating print order information on the server by carrying out an operation on the screen (perused by a versatile WWW browser) provided on the server through Internet. For the print-receiving shop, if a customer specifies storefront handing, he can receive prints by designating the shop C, and if he wishes delivery by mail, the print-receiving shop is not designated.

Incidentally, in order to represent the shops in a simple manner on the database, and to generate the order ID, an ID is given to each of the shops; it is described as the parent shop ID for the parent shop, as the reception shop ID for the shop at which reception of a customer has been made, and as the print-receiving shop ID for the shop which is specified for receiving prints.

“ORDER INF”

In the “ORDER INF”, the kind of transmission source, the reception number, the ordering time, the kind of service, the design number, the kind of recording medium, the number of recording media brought in, the total charge, the kind of charge, the charge for each charge kind, the way of receiving prints, the way of settlement, the date and time of order reception, the finishing data and time scheduled, the date and time finished, delivery date and time requested are described.

In the above, it should be judged by the kind of transmission source from what kind of system the information is transmitted, and such kinds of information as one from the print order receiving device 11, one produced by using a software in a personal computer, one produced on a browser of Internet, etc. are described.

For the reception number, a number is given consecutively in the order of reception in each of the shops.

For the ordering time, the time when a customer has settled the print order information, or in the case where transmission processing is carried out, the time when the transmission has been made is described.

The kind of service is represented by the kind of print to be produced such as a post card, a greeting card, or a calendar.

For the design number, in the case where any one of the above-mentioned kinds of service is produced, because an ID is defined for the template, the information specifying the ID is described.

The kind of recording medium indicates the medium on which a customer wishes to form an image such as a post card, a mug, or a T-shirt, and in the case of such one, because it is possible for a customer to bring in a medium which he has specified to carry out printing, the number of items brought in is described if there are any.

For the total charge, all the charges payable by the customer that come from the print order issued this time are described.

The kind of charge indicates one of the details of charges such as a print charge, a photographing charge, a dress charge, a carriage, a handling fee, or a postcard charge; in the charge for each charge kind, the expense needed in each kind of charges is described.

For the way of receiving prints, receiving at the storefront, delivery to home, or the like is described.

For the way of settlement, the way of paying the charge such as payment at the storefront, or using a credit card, bank transfer, or collect on delivery mail is described. Further, in the case where a credit card is used, it is appropriate to write the credit card number as coded in this portion, but it is desirable for security that the credit card is registered at the time of registering the customer ID, and after that, such a number is not transmitted through a network.

The order reception date and time is the time when the print order information is settled, and the settled print order information is received by the production side, and if the order is for processing at the storefront, the reception time is the time when rendering has been carried out, and if the order is transmitted, it is the time when the server 30 has finished the reception.

The finishing date and time scheduled is the finishing date and time of which the customer is informed at the time of preparing print order information; for the date and time finished, the date and time when the prints have been actually finished is to be described.

For the delivery date and time requested, in the case of delivery to home for example, it is possible for a customer to designate a delivery date and time he requests, which is to be described.

“PRINT INF”

In the “PRINT INF”, the number of prints, the name of print size, the width in the print size, the length in the print size, and the image quality are described.

Here, for the number of prints, the number of sheets to be printed is to be described; further, for the name of the print size, such a name as to represent directly the kind of the print size within the scope of this service provided is to be described; for example, it is described in such a way as L-size, KG-size, or A4.

The width of the print size is the width of a print represented in mm unit, and also the length of the print size is represented likewise.

For the image quality, such a word as to express the nature of the surface of a print, silk for example, is to be described.

“STATUS INF”

In the “STATUS INF”, the production ID, the order folder path, the backup folder path, the print folder path, the settlement of order, the state of rendering, the state of preparation for printing, the condition of a test print, the state of printing, the final processing date and time, the image forming apparatus at the output end, the state of transmission, the order type, the remarks, the status notifying mail flag are described.

These items are usually not used by a customer, and are used for pursuing (following after) the state of processing of the received print order data at the site where an image forming apparatus is placed.

The settlement of order indicates if the order, including the information on billing, is in a condition of no problem for practicing the print process. The state of rendering indicates the state whether the image is subjected to a rendering process using this image or not.

The state of preparation for printing indicates if the necessary preparation, a sheet for printing for example, has been arranged in the image forming apparatus 20.

The state of test printing indicates if test printing has been practiced.

The state of printing indicates if the objective printing has been practiced.

The date and time of final processing indicates if the ordered prints have come to the state capable of being finally put out from the laboratory (forwarding).

The output end image forming apparatus indicates which one is to be used out of the plural image forming apparatus 20 if there are some, if an image forming apparatus of a different type such as an ink jet printer is to be used, or the like. If no particular designation is carried out for this, an automatic selection is made through confirming the content of the “PRINT INF”.

Further, in the file “layout.tql” in the “LAYOUT” folder, the information on the layout of the image in editing is to be described. In this file, there are described the media data indicating the media as the object of printing, the layout frame data concerning the frame for pasting image data, character data, etc. in the template, the group data indicating the relation between the layout frames, and the object data indicating the information on edition and composition for the image data and character data. The concrete data structure is shown in FIG. 9(b-2).

Medium Information

For the medium information, the size of prints to be produced, the way of layout of the image, and the number of sheets required are memorized.

In the above, for the size and the number of sheets required, the same ones as the length in the print size, the width in the print size, and the number of prints, which has been described in the above-mentioned “PRINT INF”; however, for the way of layout of the image, in some cases the length-to-breadth ratio of the image data is not the same as the length-to-breadth ratio of the print size in printing the image. For such cases, such conditions are described as a condition for a method in which a print is made in a manner such that the white background is not left in the finished print even though a part of the image is lost, a condition for a method in which an adjustment is made in order that the whole image data are contained in the print, a condition for a method in which the enlargement or reduction processing in accordance with the print size is not carried out at all even though the length-to-breadth ratios are the same, a condition for a method in which a white frame with a certain breadth is deliberately provided, and a condition for a method in which the print is made larger by a certain amount.

Lay Frame Information

In the layout frame information, the information concerning the layout frame in making the layout of the image to the template is described.

With respect to this, as shown in FIG. 8, an image frame and a character frame are formed for a template, it is defined concerning the condition.

For its content, the following pieces of information are described; that is, the number for identifying the frame and the information on its position, the latter of which can be represented by the number of pixels or in the mm unit for example, the frame size information which can be represented by the number of pixels or in the mm unit, the order of overlapping in the case where different frames are overlapped on one another, the parameter representing a shape such as a rectangle, a circle, and an ellipsoid, the parameter representing if the data are character data or image data, and the information representing the property of the layout frame. In the above, the property of the layout frame can restrict the such functions of the frame that the change of the position of the frame is prohibited, that the change of the size is restricted or prohibited, that the change of the layer is prohibited, that the change of the image is prohibited, that the change of the mask is prohibited, that the selection of the frame itself is prohibited, and that the rotation is prohibited.

Group Information

In the group information, the relation between the plural pieces of information on the plural layout frames are memorized to make a group.

Object Information

In the object information, the information on the objects of an image or a character is described. First, as the common item, the type for representing whether the object is a character object, or an image object is described, and the number identifying the frame, which is described in the layout frame information and correlated to the type, is described.

For the image object, those pieces of edition information such as the name and the place of presence of the image data, and the place of presence of the mask image to be used for it, the position of pasting the image, the magnification, the angle of rotation, and the parameter for adjusting image quality are described.

In this invention, by describing the information for specifying and editing an image, a customer is not required actually to handle the image object (image data themselves); therefore, the deterioration of image quality is prevented to be within the smallest limit. For example, it occurs sometimes that when a customer carry out the adjustment of image quality for example, the loss or jump of gradation is produced, and for the image which has once become such one as this can not be restored at the image data receiving side. For that reason, it is important to receive the original image object even though it is done for the composition of an image and characters.

Here, with respect to a mask image, in the case where an image having a particularly complex contour is pasted, because it is difficult to represent it by a code, by preparing a monochromatic image having the same contour shape, and letting the image be pasted on that portion only, it is possible to represent a complex contour simply.

Further, in the case where the dissolving of the contour arbitrarily in the background image is desired, by defining the proportion of composition of the mask image to the background in percent, it can be carried out in a comparatively simple way.

In the case of a character object, the name of the file to define the character string, and its place of presence, and the size of the character area (width, height, and angle) are described.

In this way, without directly editing the original image at the time of making an order, the order information can be produced at a high speed from the address information and the edition information. Further, owing to the edition of the thinned image, not of the full image, also the load of the terminal can be made small. Besides, on the other hand, in the image forming apparatus, a clear print image based on a full image can be produced from the print order information.

The print order information produced in the above-mentioned manner is efficient from the viewpoint of the capacity and control if it is compressed together with the order ID folder to transmit or store it.

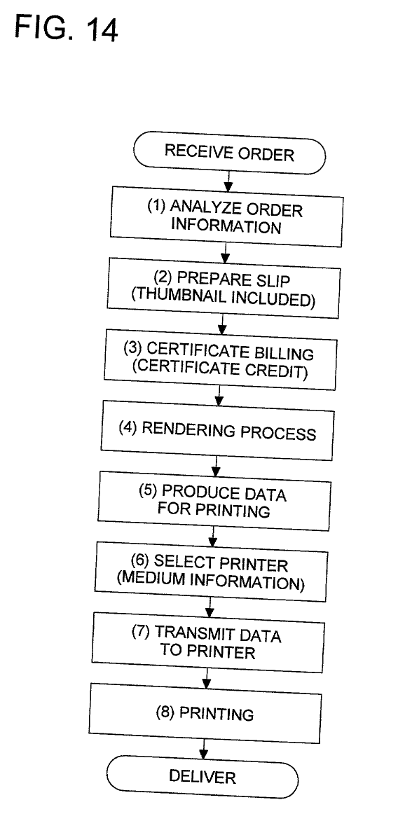

In a development facility (for example, a laboratory of a concentrated operation type practicing the processing of the print order from the plural shops collectively), as shown in FIG. 14, after the reception of the print order information, it is memorized in the print server 30.

In the server 30, the compression of the memorized print order information is defreezed, and the analysis of the print order information is carried out (FIG. 14(1)). At this time, in order to confirm the effectiveness of the print order information, it may be appropriate to carry out the certification by the user name in the portion of the extended format and the pass word. The basic processing information is extracted from the order1.txt, and by associating it with the content of the order2.txt, the slip for the confirmation of the treatment process is prepared (FIG. 14(2)).

In this case, if it is accompanied by an edition operation as in the case of a calling card, a greeting card, and a post card, by outputting and attaching the image of the merge.bmp for a simplified confirmation of the operation, the completed image can be confirmed; therefore, the confirmation that the image to be produced is right one, for example, can be carried out, which is effective.

If confirmation for billing, the certification of a credit card, for example, is necessary, the certification procedure is carried out (FIG. 14(3)), and rendering process is practiced using the order2.txt and layout.tql (FIG. 14(4)).

The rendering process is a process to compose an image again for printing, in which all the composite images are produced by using the full images, while the thinned images have been used at the time of producing the print order information.

After that, for the rendered images, data for output are produced on the basis of the order1.txt (DPOF specification: the order1.txt is altered to the AUTOPRINT.MRK as nearly untouched), and the procedure moves to printing (FIG. 14(5)). Now, from the information on the image forming apparatus at the output end, an image forming apparatus for outputting is selected (FIG. 14(6)), and the data of DPOF specification are transmitted to the image forming apparatus, (FIG. 14(7)), to carry out printing (FIG. 14(8).

As described in the above, without directly editing the original image at the time of ordering, the print order information can be produced at a high speed from the address information and edition information. Further, by the edition of a thinned image, not a full image, also the load of the terminal can be made small. Besides, on the other hand, in the image forming apparatus, a clear image based on a full image can be produced from the print order information. Further, owing to a merged composite image being attached, the comparison between the image confirmed by the customer and the image printed can be done easily, and also the failure in printing can be prevented.

Up to now, this invention has been explained by referring to the embodiment, but this invention should not be construed as one limited to the above-mentioned embodiment, and it is a matter of course that it can be suitably altered and improved. For example, it is also appropriate that the above-mentioned program is memorized in another memory medium such as a PC card or a CD, and is read out to the CPU 16 at need.

According to this invention, it is possible to provide a recording medium which has a program stored by which even a person who is not inexperienced in the operation can make the composition of an image and is capable of being read by a computer, and a print order receiving device using this recording medium.

What is claimed is:

1. A print order receiving device, comprising;
a display screen,
an image data inputting section for inputting original image data of a customer,
a memory,
object operating means capable of processing the original image data as an original image object on the display screen for a print order and editing by combining plural objects including the original image object, and
print order information producing means for producing print order information on the basis of a result of the operation for the objects,
wherein the print order information producing means produces text data in which operation information corresponding to the content of the operation for the plural objects is correlated with an address at which image data of the composed original image object is present and the print order information producing means stores the text data in the memory.

2. The print order receiving device set forth in claim 1, wherein the text data is stored in the memory as a text file.

3. The print order receiving device set forth in claim 1, wherein the operation information corresponds to at least one of operations of a color conversion, a rotation, a deformation and a size change for the original image object, and the operation information is described in the text data as data made to correspond to the image object.

4. The print order receiving device set forth in claim 3, wherein the content of the operation is substituted by a text without directly processing original image data of a customer.

5. The print order receiving device set forth in claim 1, wherein the plural objects include a character object corresponding to character string data, the object operating means is capable of combining the original image object with the character object, and the operation information includes an operation for the character object.

6. The print order receiving device set forth in claim 1, wherein the plural objects include a second image object for a specified template, the object operating means is capable of operating a layout between the second image object and the original image object, and the operation information includes a content of an operation corresponding to the layout as text data.

7. The print order receiving device set forth in claim 6, wherein the operation information includes the kind and the property of a layout frame to arrange image objects.

8. The print order receiving device set forth in claim 1, wherein the print order information producing means produces a path corresponding to a folder for storing the text data.

9. The print order receiving device set forth in claim 8, wherein the name of the path includes an order ID indicating uniquely the print order information.

10. The print order receiving device set forth in claim 8, wherein the image data of a customer and the text data are stored in the folder.

11. The print order receiving device set forth in claim 1, wherein the address and the operation information are described in a specified format on the text data.

12. The print order receiving device set forth in claim 11, wherein the address and the operation information are described together with a reserved word on the text data.

13. The print order receiving device set forth in claim 12, wherein the text data is stored in a memory as a text file.

14. The print order receiving device set forth in claim 1, wherein the print order information producing means produces a thumbnail image indicating a result of an operation for the plural objects, and the print order information producing means stores the thumbnail image coupled with the text data in a memory.

15. The print order receiving device set forth in claim 1, wherein the print order information producing means produces text data including at least one of information regarding a shop in which reception of a photograph has been made, information regarding the customer and information regarding billing.

16. The print order receiving device set forth in claim 1, wherein the inputting section comprises a memory slot and reads in image data from a removable medium in which image data of a customer are stored.

17. The print order receiving device set forth in claim 1, wherein the memory is a memory capable of storing at least image data of a customer and the memory stores the text data together with the image data of a customer.

18. The print order receiving device set forth in claim 17, wherein the memory storing the print order information is a removable medium.

19. The print order receiving device set forth in claim 17, further comprising data transferring means, wherein the print order information is capable of being transferred from the memory through the data transferring means to the outside.

20. The print order receiving device set forth in claim 1, wherein the text data includes, for each object, text data to restrict or prohibit at least one of operations of a rotation, a movement, and an enlargement or a reduction.

21. The print order receiving device set forth in claim 20, wherein the plural objects include a character object corresponding to a character string data, and if the object is a character object, the rotation of the object is prohibited.

22. The print order receiving device set forth in claim 1, wherein the print order information includes at least one of data specifying a customer and data specifying a shop.

23. A print receiving producing system, comprising
a print order receiving device,
an image forming apparatus for producing prints, and
data transferring means for transmitting print order information from the print order receiving device to the image forming apparatus, wherein
the print order receiving device comprises
a display screen,
an image data input section for inputting original image data of a customer,
a memory,
object operating means capable of combining and editing plural objects including an original image object corresponding to the original image data on the display screen, and
print order information producing means for producing print order information on the basis of a result of an operation,
wherein the print order information producing means produces text data in which operation information corresponding to a content of the operation for the original image object is correlated with an address at which image data of the composed original image object are present and the print order information producing means stores the text data in the memory, and
wherein when the image forming apparatus receives print order information the image forming apparatus, the image forming apparatus reproduces an image corresponding to a result of an operation of the print order receiving device on the basis of the original image data in accordance with the text data in the print order information and practices a print production.

24. The print receiving producing system set forth in claim 23, wherein a removable medium is utilized for the data transferring means.

25. The print receiving producing system set forth in claim 23, wherein a network is utilized for the data transferring means.

26. A print order data product capable of being read by a computer, comprising:
a data structure comprising
a folder having an ID for specifying a print order of a customer,
original image data ordered by a customer and stored in the folder, and
edition data stored in the folder and indicating the content of a composition for plural objects including the original image object corresponding to the original image data,
wherein the edition data is text data and is a text file in which first text data corresponding to an address of the original image data and second text data indicating an operation for combining the plural objects are paired and stored.

27. The print order data product set forth in claim 26, wherein the product is capable of being stored in a removable medium.

28. The print order data product set forth in claim 26, wherein the product is capable of being transferred through a network.

29. The print order data product set forth in claim 26, wherein the second text data in the order information file includes text data specifying the content of a composition of the original image object with another object.

30. The print order data product set forth in claim 29, wherein the another object is an object corresponding to a template for pasting the original image.

31. The print order data product set forth in claim 30, wherein the second text data includes designation information for a layout frame for arranging the original image in a template.

32. The print order data product set forth in claim 31, wherein the designation information for a layout frame includes at least one of the kind, position, size, and shape of the layout frame itself.

33. The print order data product set forth in claim 31, wherein the second text data includes positional information the original image object with respect to the layout frame.

34. The print order data product set forth in claim 29, wherein the another object is a character object corresponding to a character string.

35. The print order data product set forth in claim 34, wherein the folder includes character data corresponding to a character and the text file holds an address corresponding to the character data as third text data.

36. The print order data product set forth in claim 29, wherein the second text data corresponds to at least one of an angle of a rotation and a magnification of an object.

37. The print order data product set forth in claim 26, wherein the order ID is produced from data specifying at least one of a customer, a shop and a date and time of reception.

38. The print order data product set forth in claim 26, wherein the order ID includes an identifier indicating whether printing has not been finished or already finished.

39. The print order data product set forth in claim 26, wherein the folder further includes identification data corresponding to a template image and the identification data is memorized as text data paired with the original image object.

40. The print order data product set forth in claim 26, wherein the folder further stores thumbnail image data corresponding to a result of a composition, and wherein the thumbnail image data is image data produced on the basis of image data obtained by thinning out the original image data.

41. The print order data product set forth in claim 26, wherein the folder further includes at least one of the data specifying a customer and the data specifying a shop.

42. The print order data product set forth in claim 26, wherein the folder further includes data concerning date and time.

43. The print order data product set forth in claim 26, wherein the folder further includes data concerning a pass word of each customer.

44. The print order data product set forth in claim 26, wherein the text file includes, for each object, text data to restrict or prohibit at least one of operations of a rotation, a shift, and an enlargement or reduction.

45. The print order data product set forth in claim 26, wherein the folder includes data concerning a kind of a recording medium to be subjected to printing.
